(19) United States
(12) Patent Application Publication
(10) Pub. No.: US 2005/0039582 A1
(43) Pub. Date: Feb. 24, 2005

(54) Device for scoring and/or perforating a laminar material

(75) Inventor: Edmund Philip McCluskey, Bristol (GB)

Correspondence Address: NIXON & VANDERHYE, PC, 1100 N GLEBE ROAD, 8TH FLOOR, ARLINGTON, VA, 22201-4714, US

(73) Assignee: POST PRESS PRODUCTS LIMITED

(21) Appl. No.: 10/502,326

(22) PCT Filed: Jan. 23, 2003
(86) PCT No.: PCT/GB03/00285

(30) Foreign Application Priority Data
Jan. 23, 2002 (GB) 0201471.0

(51) Int. Cl. B26D 1/00

(52) U.S. Cl. 83/13; 83/659; 83/835

(57) ABSTRACT

A system for scoring and/or perforating a laminar material is described. The system comprises a device comprising a rotatable drum (1) to which may be adhered annularly around the drum projecting elements (2,5), laterally spaced from each other. In addition, the system has a rotatable wheel (6) having a groove (8,9) provided around the rim of the wheel, arranged to cooperate with the strips of projecting elements. The device also includes with means for feeding laminar material between the drum and the wheel. When this happens, each strip of projecting element (2, 3) cooperates with the respective groove in the wheel so as to score or perforate laminar material passing therebetween.

The present invention relates to a system for use in printing, to a device for preparing printed documents, as well as to elements for use in the device.

The large-scale production of books, magazines, pamphlets and other publications represents a highly automated process. Paper or card is fed serially through a set of work stations which score, fold and stitch for example with metal staples, the printed material in the appropriate manner to form the desired publication. Complex machines which integrate folder feeders with saddle stitchers to score (or crease), fold and automatically feed single-sheet covers, cards and folded signatures to the gathering chain in a single pass are known and are available for example from Müller Martini AG (Switzerland).

In some cases, it is required to produce publications, which include “tear-off” strips or sections, for example in advertising publications where reply cards are included. In this case, the publication may also be fed through a perforating device, which perforates the paper or card in an appropriate manner. However, this can generally only be carried out in a separate operation, which adds to the production time.

Preliminary scoring or creasing of the paper or card is necessary prior to folding in order to ensure that accurate folding occurs at the desired position. This is conventionally achieved by passing the paper or card over a rotating drum (X), which includes a groove (Y) (female). A cooperating wheel (Z) with a projecting (male) edge is arranged to contact the paper or card as it passes over the drum, so as to deform it into the groove (Y) in the drum (as illustrated in FIG. A hereinafter). This results in a permanent score or crease in the paper or card, which can then be used as a guide for subsequent folding.

However, there are problems with this arrangement, in that the width and depth of the crease or score that can be produced is constrained by the dimensions of the wheel. Furthermore, the male to female style of scoring or creasing produced in this way, which is illustrated in FIG. B, is not particularly desirable with many modern materials. The fibres of the outer surface become strained and may split or break during the subsequent folding process, which occurs in the direction indicated by the arrow, leading to unsightly cracking on the fold line of the document produced.

The applicants have developed.a system in which a projection strip is added to the drum to act as the male element in the scoring operation. The cooperating wheel is then provided with a groove, which acts as the female element in the scoring operation. Paper or card fed between the drum and the wheel is. then scored or creased in a “reverse style”, leading to a female into male score (FIG. C). (This arrangement is much preferred in that it is less likely to lead to cracking in the subsequent folding operation).

It has now been found that this arrangement can be readily combined with other functions, and is rendered extremely flexible by using removable strips.

The present invention provides a system for scoring and/or perforating a laminar material, said system comprising a device comprising a rotatable drum and means for feeding laminar material around said drum, at least one strip of a projecting element, which strip may be removably adhered to the surface of the said drum such that the projecting element projects from the surface thereof, a rotatable wheel having grooves provided therein, at least one groove being able to accommodate said projecting element, such that laminar material fed between the rotatable drum and the rotatable wheel is scored or perforated by the first projecting element.

Suitable laminar materials include papers of all grades including coated papers, as well as card or board.

In a particular embodiment, the strip of projecting element is provided with an adhesive backing, which facilitates adhesion to the drum. However, where this is not present, the strips may be adhered to the drum using an appropriate glue or adhesive, applied either to the drum and/or to the back of the strip as required.

The nature of the projecting element used will depend upon the intended function, for example on whether it is intended to produce a score or a perforation in the paper. Where the projecting element is required to produce a score in the laminar material, it is suitably of a ridged material and particular a ridged plastics material wherein the ridge is of an appropriate width and height to produce a score of the desired size.

Where the projecting element is required to produce a perforation in the laminar material, it is suitably a toothed material in particular a metal-tooth material and in particular a strip of steel backed metal teeth.

Such materials for use as the projecting element are available in adhesive strip form for example, from M. P. Services, Enfield, Middlesex, U.K. or from ManMat Ltd, Balasalla, Isle of Man.

Using the system of the invention, more than one strip of projecting element can be readily applied, at different positions, annularly around the drum, so that multiple scoring and/or perforating operations can be carried out at a single pass. In this case, grooves on the wheel are arranged to accommodate each different strip.

The lateral spacing between the different strips of projecting elements on the drum and the respective grooves on the wheel determine the distance between the scores and/or perforations produced in the laminar material.

Suitably one projecting element (a first projecting element) is a ridged strip that produces a score or crease in the laminar material, and another projecting element (a second projecting element) is a metal-toothed strip. This allows folded documents with a “tear-off” element to be prepared in a single pass. This is the first system which allows both a scoring and a perforating operation to be carried out at the same time.

Alternatively, the second projecting element may be a further ridged strip, which means that covers with a double fold can be produced in a single pass. The region between the folds may form a spine or backing region for a book.

Any number of additional strips of projecting elements may be added to produce combinations or folds and/or scores as desired. The facility to add additional elements in this way means that many operations which previously had to be carried out “offline” for example, by folding or creasing, or perforating on a separate machine, can now be carried out “online” with huge cost savings.

In particular preferred embodiments for instance, a pair of strips of projecting elements able to produce perforations is provided, one on either side of a projecting element able to produce is a crease. This allows the rapid and economical production of tear-off postcards.

Alternatively, the multi-creasing option, for example using three strips of creasing element provides the facility for producing a variety of folded covers or folders for stationary applications.

Strips of projecting elements are suitably adhered to the drum prior to commencement of the scoring and/or perforating operation in a preliminary rotation of the drum. Such an operation forms a further aspect of the invention.

Where the strips are provided with an adhesive backing, these may be applied directly to the drum. Where no adhesive backing is included however, a glue or adhesive may be applied to the back of the strip and/or the desired position on the drum prior to the preliminary rotation. The glue or adhesive should be strong enough to hold the strip in position during scoring or perforating operations. However, it may be removable by mechanical action when the strips are required to be changed.

Thus the invention further provides a method for preparing a device for scoring and/or perforating a laminar material, said method comprising positioning a first strip of projecting element into a first groove of a wheel of the system as defined above, contacting the wheel with the rotatable drum of the said system, so that the backing of the strip contacts the surface of the drum, rotating the drum through 360° so that the strip becomes adhered to the drum, placing a further strip of second element into a second groove of said wheel so that the backing of the strip contacts the surface of the drum, and rotating the drum through 360° so that the strip of second projecting element becomes adhered to the drum, and thereafter if desired or necessary, adjusting the relative position of the drum and the wheel so that laminar material can pass there between and the first and second projecting elements produce the desired score or perforation therein.

If necessary or desired, further strips of projecting elements may be added to the drum using a similar procedure.

Devices obtained by this method form a further aspect of the invention. In a particular embodiment of the present invention, there is provided a device for scoring and/or perforating a laminar material, said device comprising a rotatable drum which has provided thereon, a first projecting element arranged annularly around the drum, a second projecting element also arranged annularly around the drum and laterally spaced from said first projecting element, a rotatable wheel having a first groove and a second groove provided around the rim of the wheel and means for feeding laminar material between the drum and the wheel, whereupon the first projecting element cooperates with the first groove in the wheel and the second projecting element cooperates with the second groove in the wheel so as to score or perforate the laminar material.

As described above, one or more additional projecting elements may be removably added to the drum, as well as corresponding grooved elements included in the wheel, so as to produce the desired number of folding/creasing or perforating operations at a single pass. The additional projecting elements are suitably arranged at the desired distance from the first or second projecting elements.

The strips of projecting elements and in particular strips comprising the first and/or the second projecting elements may be removeable from the drum by peeling them off, either when they become worn, or when a different type of scoring and/or perforating operation is required. They are preferably accurately positioned on the drum so as to produce the desired product.

The wheel is suitably of a durable material such as metal or a hard synthetic material such as nylon or polypropylene.

Suitably the wheel is modular in nature wherein each groove is provided on a different annular element. Preferably, at least one of the annular elements is moveable with respect to the hub or axle of the wheel. This allows for alteration of the spacing between the features such as the fold or perforation, which are produced by the may be added as a result of the interaction of the second projecting element with the second groove. Maximum flexibility in terms of the relative positioning of the grooves, for example, the first and second grooves, is achieved where all annular elements are moveable along the hub or axle.

Moveable elements should be fixable relative to the axle to ensure accurate spacing. This may be achieved by providing variously spaced engagement elements, which interact with co-operating elements on the annular element. Conveniently however, a moveable annular element is fixable at any position on the hub or axle using an appropriate adhesive or glue.

In a particular embodiment, the hub or axle of the wheel, or annular elements thereof, is mounted on a support shaft, which is provided with a clamp, allowing it to be fixed in various positions with respect to the drum. For example the clamp may be suitable for fixing the wheel to a shaft of the feeder device. In this case, the position of the folds can be modified by moving the wheel or annular elements thereof laterally with respect to the drum. If desired, individual female grooved “heads” may be added to the system. These may also be clampable in position relative to the drum so that additional scoring or perforating operations can be introduced. Such heads, which are effectively, individual grooved wheels or annular elements, form a further aspect of the invention.

Preferably moveable annular elements are removable from the hub or axle. This allows annular elements to be interchanged so that they match with various combinations of first and second projecting elements, allowing different combinations of folds and/or perforations to be produced.

As explained above, the size of the score or crease formed in the laminar material is dependent upon the width and height of ridge on the projecting element. However, the groove in the wheel, which cooperates with this ridge, must be of sufficient depth and width to accommodate the ridge. Various annular elements may be produced with different widths and depths of groove, which may be interchangeable, where these are removable, so as to allow score lines of different types, to be produced.

Suitably the wheel and/or annular elements thereof are rotatably mounted on a shaft, which can fit onto a boss, adjacent the drum.

In some cases, where the nature of the first and second elements are different, the size of the backing material may be different, which means that the first and second projecting elements may project from the drum by different amounts. Suitably the diameter of the wheel is varied in the corresponding regions in order to ensure that pressure on laminar material in the region of the first and second grooves is sufficient to allow the first and second projecting elements passing to create the desired feature (score or crease or perforation) therein. Where the wheel is a single unit, this needs to be machined to the requisite specification. However, where the wheel is modular, the annular elements may be produced such that they individually have the desired diameter.

If required, further projecting elements may be provided on the drum and corresponding grooves provided in the wheel, so that additional scoring and/or perforating lines may be introduced into the laminar material at the same time.

The device of the invention is suitably incorporated into a production machine, which may include feeding, trimming, stitching and folding devices, to automatically produce documents.

The projecting elements of the invention may be supplied on plane drums if required. However, existing machines, which include female grooves in the drum (as illustrated in FIG. A) may be modified to form devices of the invention, by application of suitable strips of projecting elements over the grooves, and the use of a wheel as described above, in place of the “male” wheel conventionally used.

According to a further aspect of the invention, there is provided a kit of parts, comprising an strip of a projecting element and a wheel having around the rim thereof, grooves, at least one of which can cooperate with the projecting element so as to produce a score or perforation in a laminar material passing therebetween. Preferably the kit comprises strips of two different types of strip of projecting element, wherein one type of projecting element is a ridged material able to produce folding in a laminar material, and the other type being a toothed material able to produce perforations. In this case, the wheel includes at least one groove able to accommodate each different type of projecting element. High levels of flexibility are achievable where the wheel comprises one or more annular elements as described above.

Preferably the strips are adhesive-backed. Alternatively, the kit may include glue or adhesive which is suitable for fixing the strip to the drum.

Preferably, the wheel supplied in the kit comprises a series of annular elements as described above, each with a single groove of differing dimensions so that various combinations of score and/or perforation may be achieved by appropriate selection of annular elements making up the wheel.

A particular example of a kit of parts, comprises a strip of a first projecting element as described above, a strip of a second projecting element as described above, and a wheel having around the rim thereof, a first groove which can cooperate with the first projecting element and a second groove which can cooperate with the second projecting element so as to produce a score or perforation in a laminar material.

Thus a further aspect of the invention provides a method for preparing a scored and/or perforated laminar material, said method comprising passing said material between a drum and a wheel of a device obtained using a system as described above, or as specifically exemplified above such that the projecting. elements cooperate with their respective grooves in the wheel respectively, so as to produce a score and/or perforation in the laminar material.

The invention will now be particularly described by way of example with reference to the accompanying diagrammatic drawings in which

FIG. A is a schematic drawing (not to scale) showing a conventional score/creasing arrangement;

FIG. B is a diagram showing a score produced by the device of FIG. A and the direction of subsequent folding;

FIG. C is a diagram showing a reverse style score produced for example, by the device of the invention, and the direction of subsequent folding;

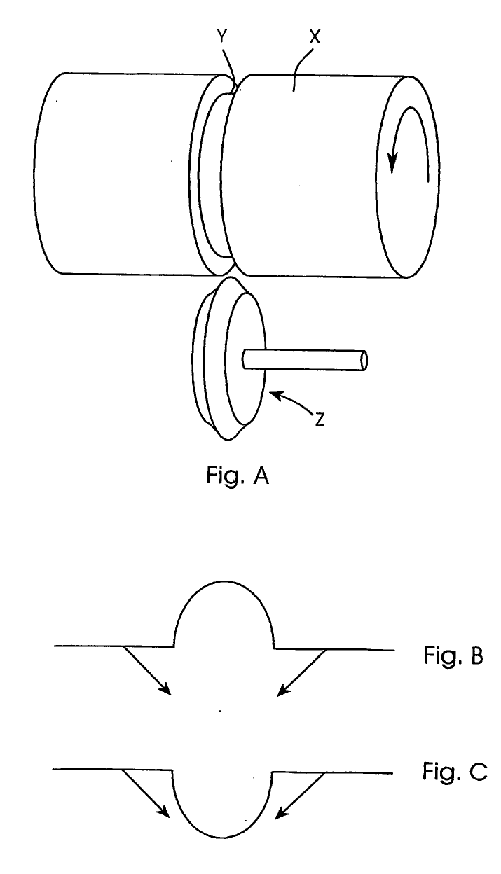

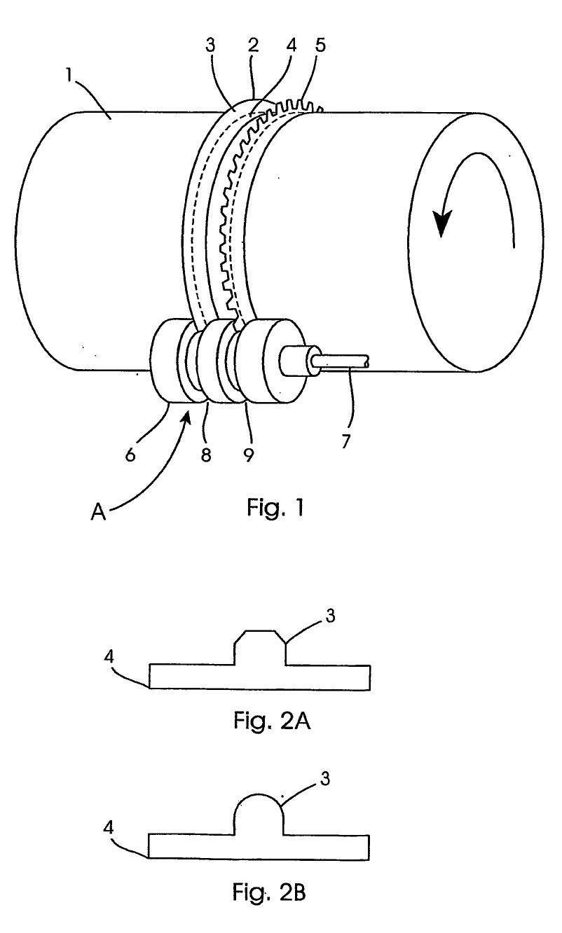

FIG. 1 is a diagrammatic drawing (not to scale) of the device of the invention;

FIG. 2 is a side view of a range of projection strips which may be used in the device of FIG. 1;

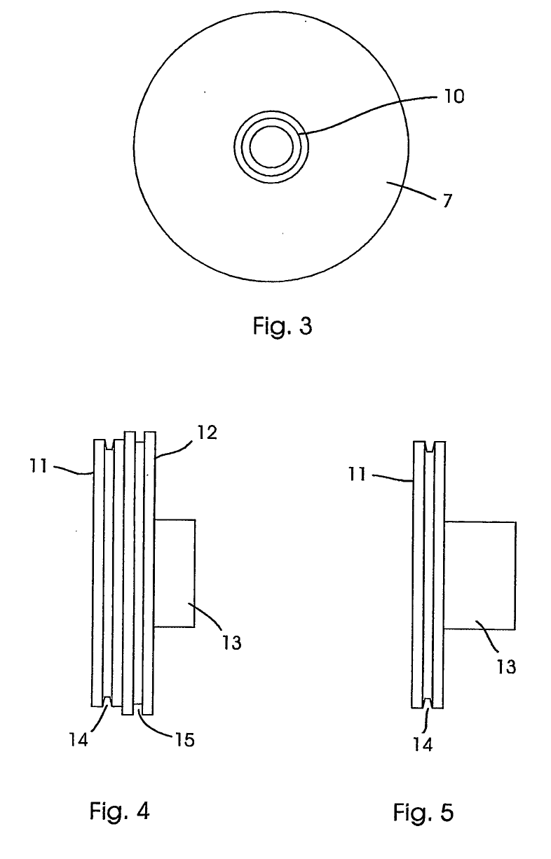

FIG. 3 is an end view of a wheel used in the device of the invention;

FIG. 4 is a side view of an alternative wheel arrangement of the invention;

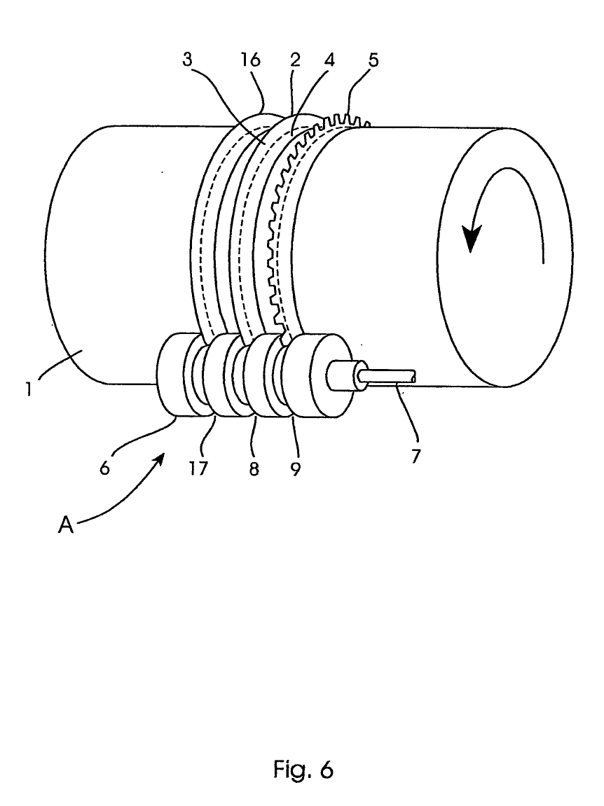

FIG. 5 is a side view of an element of the wheel of FIG. 4;

FIG. 6 shows an alternative embodiment of the device of FIG. 1, to which an additional strip of projecting element has been added;

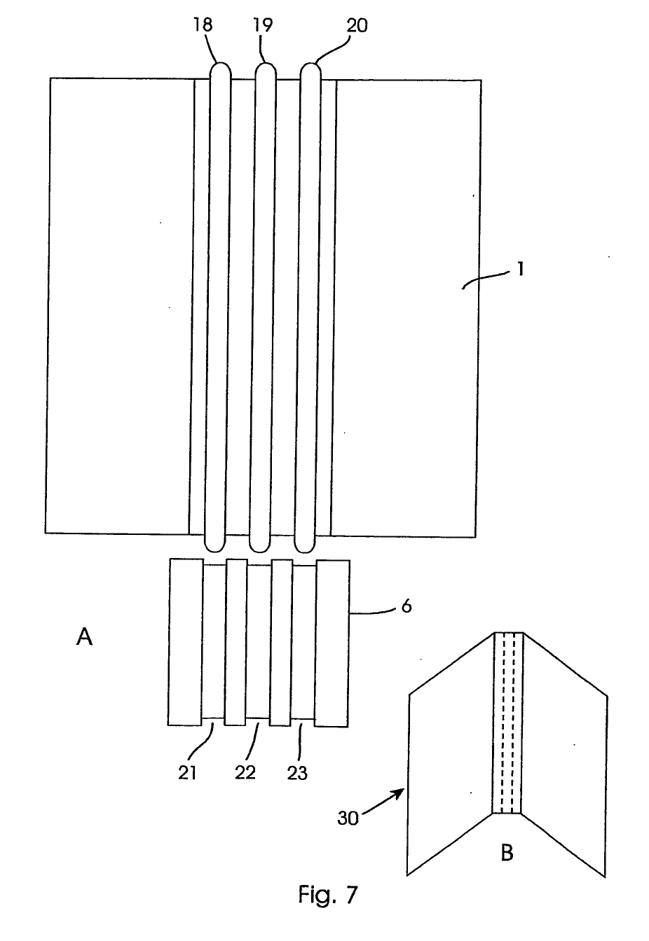

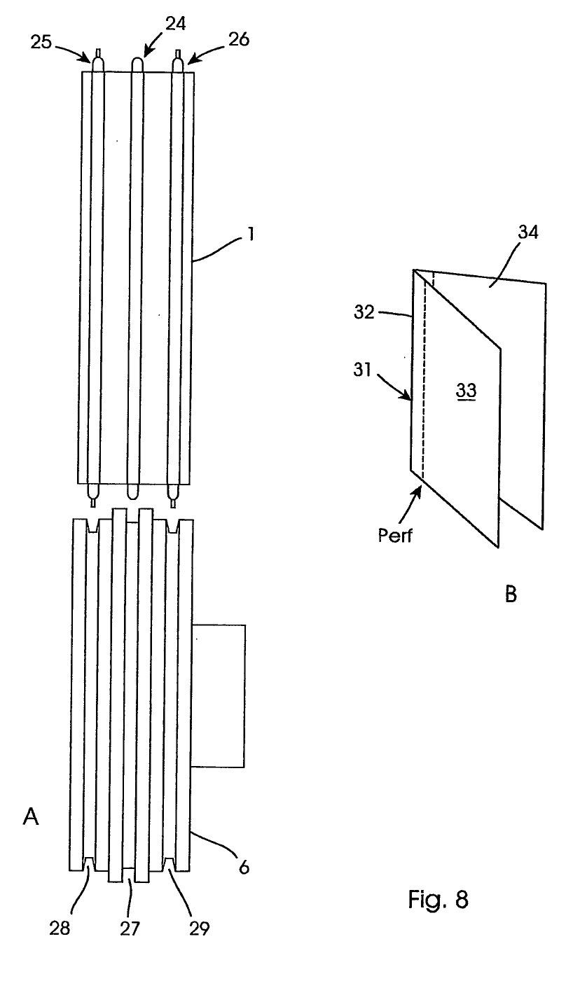

FIGS. 7 and 8 illustrate possible combinations which may be used in the system of the invention, together with the products thereof;

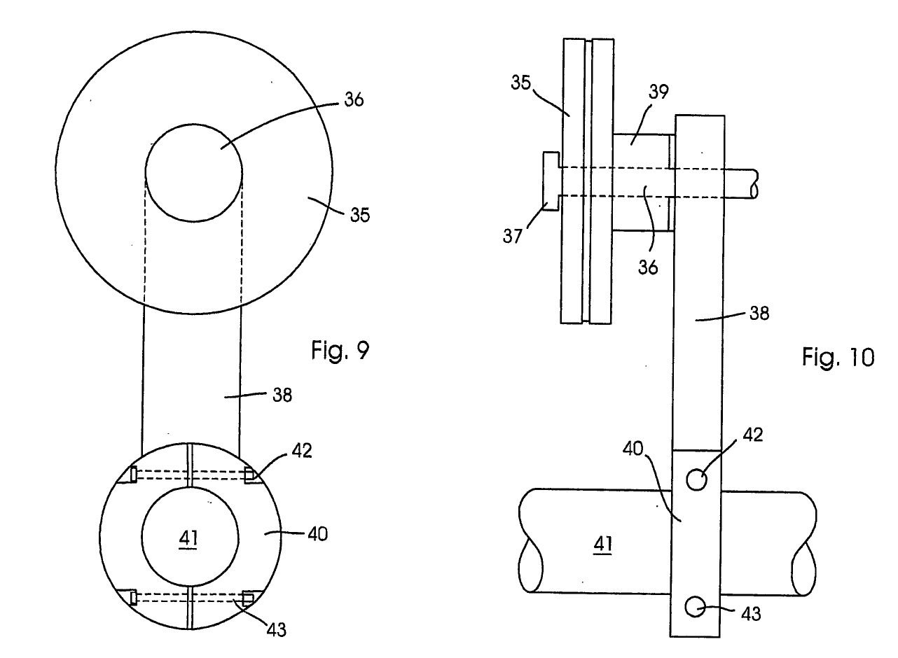

FIG. 9 shows a side view of a clampable female element which may be used in an embodiment of the system of the invention; and

FIG. 10 shows a front view of the wheel element of FIG. 9.

The device (FIG. 1) comprises a rotatable drum (1) around which is fed a first projection strip (2) of a plastics material. The strip (2) comprises a ridge (3) projecting from a base (4) (see also FIG. 2). The ridge (3) may have variety of profiles and widths, for example ranging from 1 to 4 pt, but is preferably rounded as shown in FIG. 2B, for creasing or folding.

The undersurface of the base (4) is adhered to the surface of the drum (1) by means of an adhesive.

A second metal-toothed strip (5) is also adhered to the surface of the drum (1) but is laterally spaced from the strip (2).

A wheel (6) is rotatably mounted on its axle (7) on a support (not shown). It is provided with a first groove (8) and a second groove (9) arranged to interconnect with the strip (2) and the strip (5) respectively.

In order to construct this arrangement, the strips (2, 5) are suitably provided with an adhesive backing. They may be accurately positioned on the drum by placing the ridge or metal teeth in the corresponding groove (8,9) in the wheel (7). The drum (1) and wheel (7) are then positioned so that they are in close contact with each other, and then rotated in opposite directions, whilst feeding the strips (2,5) into the grooves (8,9). As the drum (1) and wheel (7) rotate, the adhesive strip will adhere to the surface of the drum (1). Once the drum has completed a single rotation, strips (2,5) will be adhered completely around the circumference, and so any remaining unfed strip may be cut.

The pressure between the drum (1) and the wheel (7) is adjusted for the laminar material, which is to be processed in it, and the device is then ready for use.

In use, paper or card is fed between the wheel (6) and the drum (1), which rotate in opposite directions. As a result of contact with the strip (2), the paper or card is forced into the groove (8) giving rise to a female into male crease as illustrated in FIG. C. In addition, the paper or card will be perforated by contact with the metal teeth of the strip (5), which penetrate the paper or card and project into the groove (9) as the drums rotate. The distance between the fold and the perforation created is equivalent to the distance between the strips (2,5) and also the grooves (8,9).

Subsequent folding of the paper or card about the crease may be carried out automatically in a downstream processor. The fold will be accurately positioned in the laminar material.

Furthermore, an additional feature, in this case a perforation, is introduced in a single pass.

The wheel (7) suitably comprises a solid wheel, rotatably mounted on a hollow shaft (10) (FIG. 3). It can then be readily supported on a boss, for example using bolts, and positioned in relation to the drum (1) so that an appropriate pressure is applied to laminar material passing therebetween.

In the embodiment of FIG. 4, the wheel comprises two annular elements (11, 12). One of these elements (11) is of metal, such as stainless steel, and is integral with a central hub (13). A groove (14) is provided around the rim of the element (11), which is of a suitable size and shape to allow it to cooperate with the first projecting element, in this case a ridged plastic element that produces a score line in the laminar material.

The second annular element (12) is of a hard nylon material, and is arranged to removably fit over the hub (13). As illustrated, this element abuts the element (11), but it may if desired be fixed in a different position on the hub to produce laminar material with differently spaced score or perforation features. A groove (14) is provided around the rim of the annular element, which is sized such that it can accommodate the teeth of a metal-toothed strip, capable of producing perforations in a laminar material.

The diameter of the annular element (12) is greater than that of the element (11). The difference is designed to compensate for the fact that the backing strip on the metal-toothed strip used to perforate the card is thinner than the backing strip on a conventional ridged plastic strip. Therefore, in order to ensure that both elements contact the laminar material with suitable pressure to effect the scoring or perforation operation, the rim of the element (12) is closer to the drum (1) than the rim of the element (11) during a scoring and/or perforating operation.

If desired, the annular element (11) may also be removable from the hub (13) to increase the flexibility of the system, as different elements may be fixed onto the hub in different orders, as required.

The embodiment illustrated in FIG. 6 is similar to that of FIG. 1, except that an additional folding strip (16) has been added. In this case, the wheel 6 includes an additional groove (17) accommodate this strip (16) during rotation of the wheel. This arrangement allows the simultaneous productions of two folds and a perforation.

Particular combinations of three strip systems of the invention, and the products obtained thereby are illustrated in FIG. 7 and 8.

In the embodiment of FIG. 7A, the drum (1) has three ridges (18, 19, 20) projecting therefrom, as a result of the adhesion of suitable adhesive-backed strips to the drum (1). In this case, the wheel (6) has three female grooves (21, 22 and 23) aligned with the ridges (18, 19, 20) respectively, so that laminar material such as card, passing between the wheel and the drum has multiple creases introduced therein. Such a facility is particularly useful in the production of covers such as the cover (30) illustrated in FIG. 7B.

In the embodiment of FIG. 8A, the drum (1) in provided with a ridge (24) which is arranged between two rows of perforating teeth (25, 26). Again the wheel (6), which in this case is modular, has three female grooves (27, 28 and 29) aligned with the ridge (24) and teeth (25, 26) respectively, so that laminar material such as card, passing between the wheel and the drum is both creased and perforated on either side of the crease. Such a facility is particularly useful in the production of for example, postcard type displays such as that (31) illustrated in FIG. 8B. Such an arrangement, which includes a crease or fold (32) with two detachable postcards (33,34) would previously only have been obtainable using a secondary “offline” process, which adds to the difficulty and the time of the operation.

FIG. 9 illustrates a moveable female “head” or wheel (35) which may form an additional element of the system, to provide the facility to flexibly add more scores or perforations to a particular machine. The wheel (35) is mounted at the end of an axle (36) by means of a bolt (37) (FIG. 10). The axle (36) is itself rotatably mounted in a support shaft (38). A spacer (39) ensures that the wheel (35) and the support shaft (38) do not come into contact with each other. At the base of the support shaft (38) is a clamp (40), which is fixable to a shaft of a cover feeder (41) by means of a pair of locking screws (42, 43).

This element can therefore be added to the system and fitted at any point relative to the drum to introduce yet further folding or perforating facility. All that needs to be done is that an additional adhesive backed strip of either folding or perforating material is applied to the drum at the required position, for example using the wheel (35) which is clamped in the required position.

Using the device of the invention, accurate scoring and/or perforation of laminar material can be carried out. The device is flexible in that parts and elements can be readily changed to bring about a wide variety of different scoring and/or perforation patterns. The system provides the only means of scoring and perforating laminar materials at the same time, using processing machines of this type.

1. A system for scoring and/or perforating a laminar material, said system comprising a device comprising a rotatable drum and means for feeding laminar material around said drum, at least one strip of a projecting element, which strip may be removably adhered to the surface of the said drum such that the projecting element projects from the surface thereof, a rotatable wheel having grooves provided therein, at least one groove being able to accommodate said projecting element, such that laminar material fed between the rotatable drum and the rotatable wheel is scored or perforated by the first projecting element.

2. A system according to claim 1 wherein the said projecting element is a ridged material wherein the ridge is suitable for producing a score in the laminar material.

3. A system according to claim 2 wherein the ridged material is a plastics material.

4. A system according to claim 1 wherein the said projecting element is a toothed material capable of producing a perforation in the laminar material.

5. A system according to claim 4 wherein the toothed material is a strip of steel backed metal teeth.

6. A system according to claim 1 wherein the strip of projecting element has an adhesive backing.

7. (canceled)

8. A system according to claim 7 wherein the wheel is provided with at least two grooves, at least one of which is able to accommodate said one type of projecting element, and at least one of which is able to accommodate the said other type of projecting element.

9. A system according to claim 1 wherein the wheel comprises a plurality of annular elements, and grooves are located on different annular elements.

10. A system according to claim 9 wherein at least one of the annular elements is moveable with respect to the hub or axle of the wheel.

11. A system according to claim 9 wherein the annular elements are removable from the hub or axle.

12. A system according to claim 1 wherein an axle of the wheel, or a grooved annular element, is mounted on a support shaft, which is provided with a clamp, allowing it to be fixed in various positions with respect to the drum.

13. A publication production machine comprising a system according to any one of the preceding claims, wherein strips of projecting element are adhered annularly around the drum such that the projecting element projects from the surface thereof, and grooves of the rotatable wheel are arranged to accommodate the projecting element, such that laminar material fed between the rotatable drum and the rotatable wheel is scored or perforated by the first projecting element.

14. A kit of parts, comprising a strip of a projecting element and a wheel having around the rim thereof, grooves, at least one of which can cooperate with the projecting element so as to produce a score or perforation in a laminar material passing therebetween.

15. A kit according to claim 14 wherein the strip of projecting element has an adhesive backing.

16. (canceled)

17. A kit according to claim 14 wherein the wheel comprises one or more annular elements as defined in claim 8.

18. A method for preparing a device for scoring and/or perforating a laminar material, said method comprising positioning a first strip of projecting element into a first groove of a wheel of the system as defined in claim 1, contacting the wheel with the rotatable drum of the said system of claim 1, so that the backing of the strip contacts the surface of the drum, rotating the drum through 360° so that the strip becomes adhered to the drum, placing a further strip of second element into a second groove of said wheel so that the backing of the strip contacts the surface of the drum, and rotating the drum through 360° so that the strip of second projecting element becomes, adhered to the drum, and thereafter if desired or necessary, adjusting the relative position of the drum and the wheel so that laminar material can pass there between and the first and second projecting elements produce the desired score or perforation therein.

19. A method according to claim 18 wherein the said first strip and said further strip of projecting element are of different types of projecting element.

20. A method for preparing a scored and/or perforated laminar material, said method comprising passing said material between a drum and a wheel of a device prepared according to the method of claim 18, such that the first and further strips of projecting element cooperate with said first and second grooves in the wheel respectively, so that each produces a score and/or perforation in the laminar material.

21. A device for scoring and/or perforating a laminar material, said device comprising a rotatable drum which has provided thereon, a first projecting element removably adhered annularly around the drum, a second projecting element also removably adhered annularly around the drum and laterally spaced from said first projecting element, a rotatable wheel having a first groove and a second groove provided around the rim of the wheel and means for feeding laminar material between the drum and the wheel, whereupon the first projecting element cooperates with the first groove in the wheel and the second projecting element cooperates with the second groove in the wheel so as to score or perforate the laminar material.

22. A device according to claim 21 wherein the first and/or second projecting elements is a ridged material wherein the ridge is suitable for producing a score in the laminar material.

23. A device according to claim 22 wherein the ridged material is a plastic material.

24. A device according to claim 21 wherein first and/or second projecting element is a toothed material capable of producing a perforation in the laminar material.

25. A device according to claim 24 wherein the toothed material is a strip of steel backed metal teeth.

26. A device according to claim 21 which further comprises one or more additional projecting elements removably adhered annularly around the drum at a predetermined distance from said first and/or second projecting elements.

27. A device according to claim 21 wherein one of the first or second projecting elements is a ridged strip that produces a score or crease in the laminar material, and the other projecting element is a metal-toothed strip which perforates a laminar material.

28. A device according to claim 21 wherein both the first and second projecting elements comprise a ridged strip able to produce a score or crease in a laminar material.

29. A device according to claim 21 wherein the wheel comprises a plurality of annular elements, and the first and second grooves are located on different annular elements.

30. A device according to claim 29 wherein at least one of the annular elements is moveable with respect to the hub or axle of the wheel.

31. A device according to claim 29 wherein the annular elements are removable from the hub or axle.

32. A grooved wheel or annular element, for use in the system according to claim 1, which wheel or annular element is provided with a clamp to allow to be fixed relative to a drum of said system.

33. A publication production machine comprising a device according to claim 21.

34. A system for scoring and/or perforating a laminar material as defined in claim 1, substantially as hereinbefore described with reference to the accompanying drawings.

35. (canceled)
